(19) United States
(12) Patent Application Publication
(10) Pub. No.: US 2024/0226800 A9
(43) Pub. Date: Jul. 11, 2024

(54) STRATIFIED HYDROPHILIC MEDIA FOR LIQUID/GAS CONTACTORS

(71) Applicant: Mojave Energy Systems, Inc., Palo Alto, CA (US)

(72) Inventor: Rohan Morajkar, Sunnyvale, CA (US)

(21) Appl. No.: 17/969,864

(22) Filed: Oct. 20, 2022

(51) Int. Cl. B01D 53/18; B01D 53/14

(52) U.S. Cl. CPC B01D 53/18; B01D 53/1425; B01D 53/1493; B01D 2252/20; B01D 2259/40083

(57) ABSTRACT

A liquid/gas contactor unit includes a unit housing having a liquid inlet and a liquid outlet, and an air inlet and an air outlet. The liquid inlet and the liquid outlet are configured to flow liquid through the unit housing in a gravity liquid flow direction. The air inlet and the air outlet are configured to flow air through the unit housing in an air flow direction. A plurality of porous media layers are contained within the unit housing and along the air flow channel. Each porous media layer is separated from an adjacent porous media layer by an air gap. Each porous media layer has opposing major surfaces separated by a thickness. The opposing major surfaces are orthogonal to the gravity liquid flow direction.

### GOVERNMENT INTEREST

This invention was made with Government support under Subcontract No. RAD-AC-FT, G014.3930.01 awarded by the Department of Energy. The Government has certain rights in this invention.

### FIELD

The present disclosure relates generally to liquid/gas contactors and method of using the same.

### SUMMARY

The present disclosure relates generally to a liquid/gas contactor unit and method of using the same. This liquid/gas contactor unit utilizes stratified hydrophilic media or sheets of hydrophilic media where the liquid flows via gravity through the thickness of each layer of hydrophilic media. This configuration may provide improved wetting uniformity along each layer of hydrophilic media and may improve efficiency of the liquid/gas contactor.

The present disclosure is directed to a liquid/gas contactor unit includes a unit housing having a liquid inlet and a liquid outlet, and an air inlet and an air outlet. The liquid inlet and the liquid outlet are configured to flow liquid through the unit housing in a gravity liquid flow direction. The air inlet and the air outlet are configured to flow air through the unit housing in an air flow direction. A plurality of porous media layers are contained within the unit housing and along the air flow channel. Each porous media layer is separated from an adjacent porous media layer by an air gap. Each porous media layer has opposing major surfaces separated by a thickness. The opposing major surfaces are orthogonal to the gravity liquid flow direction.

The present disclosure is directed to a method of forming an air/liquid interface including providing the liquid/gas contactor unit described herein, and flowing liquid into the liquid inlet, through the plurality of porous media layers, and out the liquid outlet via gravity. The liquid flows onto an upstream major surface of each porous media layer, through the thickness of each porous media layer, and out a downstream major surface of each porous media layer. The method includes flowing air into the air inlet, through the plurality of porous media layers, and out the air outlet, air flows through the thickness of the porous media layer forming a liquid/gas interface within the thickness of the porous media layer.

The present disclosure is directed to a method of conditioning an airflow including providing the liquid/gas contactor unit described herein, and flowing liquid desiccant into the liquid inlet, through the plurality of porous media layers, and out the liquid outlet via gravity. The liquid desiccant flows onto an upstream major surface of each porous media layer, through the thickness of each porous media layer, and out a downstream major surface of each porous media layer. The method includes flowing air into the air inlet, through the plurality of porous media layers, and out the air outlet, air flows through the thickness of the porous media layer forming a liquid/gas interface within the thickness of the porous media layer. The method removes or adds water to the air flowing through the porous media layers.

### BRIEF DESCRIPTION OF THE DRAWINGS

The discussion below makes reference to the following figures, wherein the same reference number may be used to identify the similar/same component in multiple figures.

FIG. 1 is a schematic diagram of an illustrative liquid/gas unit;

FIG. 2 is a schematic diagram of illustrative porous media layers of a liquid/gas unit;

FIG. 3 is a schematic diagram of illustrative porous media layers of a liquid/gas unit; and

FIG. 4 is a schematic diagram of an illustrative air conditioning system utilizing the liquid/gas units described herein.

The figures are not necessarily to scale and are presented for purposes of illustration and not limitation. The figures depict one or more aspects described in this disclosure. However, it will be understood that other aspects not depicted in the figures fall within the scope and spirit of this disclosure.

### DETAILED DESCRIPTION

The present disclosure relates generally to a liquid/gas contactor unit and method of using the same. This liquid/gas contactor unit utilizes stratified hydrophilic media or sheets of hydrophilic media where the liquid flows via gravity through the thickness of each layer of hydrophilic media. This configuration may provide improved wetting uniformity along each layer of hydrophilic media and may improve efficiency of the liquid/gas contactor.

The liquid/gas contactor unit and method of using the same may operate at any useful temperature and pressure. The liquid/gas contactor unit and method of using the same may operate at a standard temperature and pressure. The liquid/gas contactor unit may operate at atmospheric pressure or slightly above atmospheric pressure. The liquid/gas contactor unit may operate at atmospheric pressure in a range from 1 to 2 atmospheres, or from 100 to 200 kpa. The liquid/gas contactor unit may operate at a temperature range suitable for aqueous solutions. The liquid/gas contactor unit may operate at a temperature range in a range from 0 to 100 degrees Celsius, or from 10 to 50 degrees Celsius.

The present disclosure provides stratified hydrophilic media or sheets of hydrophilic media and achieves uniform wetting of the stratified hydrophilic media or sheets of hydrophilic media with the liquid flowing through the liquid/gas contactor unit. This uniform wetting results in better contact with gas and improving mass and/or heat transfer between the gas and liquid at this gas/liquid interface within the stratified hydrophilic media or sheets of hydrophilic media.

The present disclosure provides a liquid/gas contactor unit having stratified hydrophilic media or sheets of hydrophilic media that are parallel to each other, separated by air gap from each other, and arranged perpendicular or orthogonal the direction of liquid flowing through the liquid/gas contactor unit. The direction of liquid flowing is parallel with and in the direction of gravity.

The present disclosure utilizes hydrophilic and capillary forces acting against gravity on the liquid flowing through the liquid/gas contactor unit. In a continuous media, hydrophilic forces are acting on a drop across all directions thereby balancing out. Thus, the only forces a droplet is subject to are drag and gravity. By stratifying the media into strips or layers, the droplets at the downstream surface of the media layer (exposed to an air gap) do not have a hydrophilic force pulling the drop in the downward direction resulting in the gravitational force being balanced by hydrophilic force up to the build-up of a certain mass of liquid. This balance may determine the height or thickness of the layer of media before another layer starts and the pattern repeats.

The term “major surface” refers to a surface of an element that has the largest surfaces area of the element.

The terms “upstream” and “downstream” refer to relative positions of elements of the liquid/gas contactor unit and systems described in relation to the direction of liquid or air flow as it flows through the liquid/gas contactor unit and system.

The terms “gas” and “air” are used interchangeably herein.

The terms “liquid” and “liquid desiccant” are used interchangeably herein.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

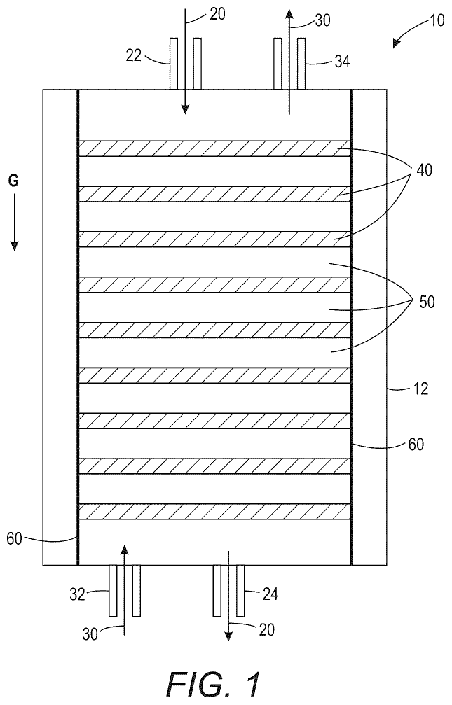

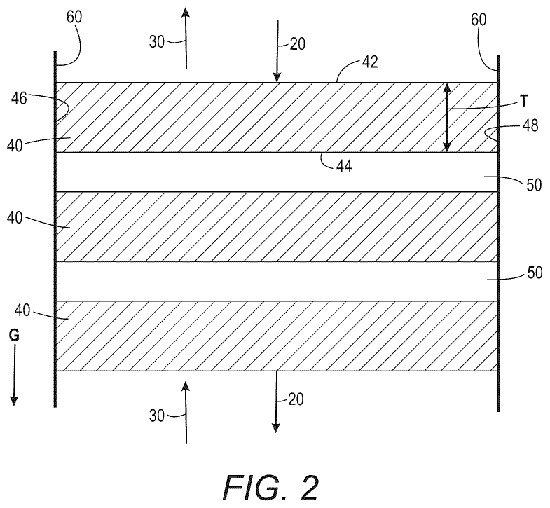

FIG. 1 is a schematic diagram of an illustrative liquid/gas contactor unit 10. FIG. 2 is a schematic diagram of illustrative porous media layers of a liquid/gas contactor unit 10. FIG. 2 illustrates three porous media layers 40. Adjacent porous media layers 40 are separated by an air gap 50.

The present disclosure is directed to a liquid/gas contactor unit 10 including a unit housing 12 having a liquid inlet 22 and a liquid outlet 24, and an air inlet 32 and an air outlet 34. The liquid inlet 22 and the liquid outlet 24 are configured to flow liquid 20 through the unit housing 12 in a gravity liquid flow direction G. The air inlet 32 and the air outlet 34 are configured to flow air 30 through the unit housing 12 in an air flow direction.

A plurality of porous media layers 40 are contained within the unit housing 12 and along the air flow 30. Each porous media layer 40 is separated from an adjacent porous media layer 40 by an air gap 50. Each porous media layer 40 has opposing major surfaces 42, 44 separated by a thickness T. The opposing major surfaces 42, 44 are orthogonal to the gravity liquid flow direction G.

Each porous media layer 40 includes opposing major surfaces 42, 44 that may be parallel to each other. A first major surface 42 is a liquid upstream surface where liquid 20 flows into the porous media layer 40. The liquid 20 flows into the porous media layer 40 and through the porous media layer 40 to the second major surface 44 being the liquid downstream surface 44.

The liquid 20 moves through the thickness T of the porous media layer 40 with the force of gravity until capillary forces balance the force of gravity and allow the liquid 20 to build up in at the liquid downstream surface 44 of the porous media layer 40. The hydrophilic forces of the porous media layer 40 may also assist in balancing the force of gravity and allow the liquid 20 to build up in at the liquid downstream surface 44 of the porous media layer 40.

This liquid mass build-up at the liquid downstream surface 44 of the porous media layer increases the liquid saturation of the porous media layer 40 to saturation levels above 50%. These high saturation levels improve the liquid/air interface of the liquid/gas contactor unit 10 and increases the volumetric efficiency of the porous media of the liquid/gas contactor unit 10.

Each porous media layer 40 has a length extending from a first side surface 46 to an opposing second side surface 48. The first side surface 46 and the second side surface 48 may define the thickness T of the porous media layer 40. Each porous media layer 40 may have two opposing sets of side edges that each define the thickness T of the porous media layer 40, defining a solid rectangle or cuboid.

Each porous media layer 40 may have a high aspect ratio. Each porous media layer 40 has a length value that is greater than the corresponding thickness value. The thickness value T is co-incident with the gravity liquid flow direction G. The plurality of porous media layers 40 each may have an aspect ratio (length:thickness) of at least 10:1, or at least 25:1, or at least 50:1, or at least 100:1. Each porous media layer 40 may have a thickness value T in a range from 2 mm to 100 mm, or from 5 mm to 50 mm.

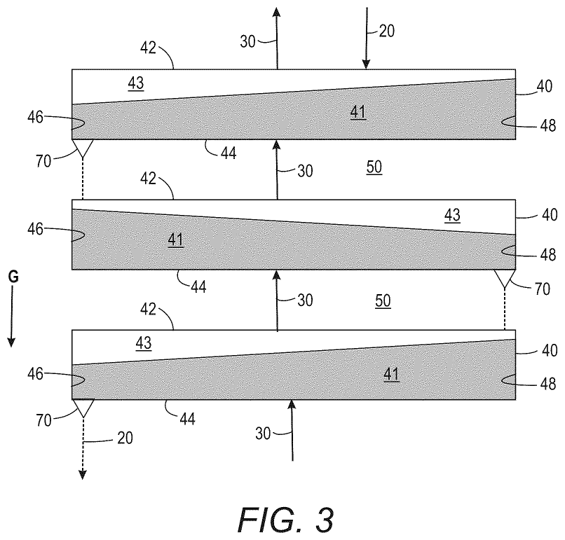

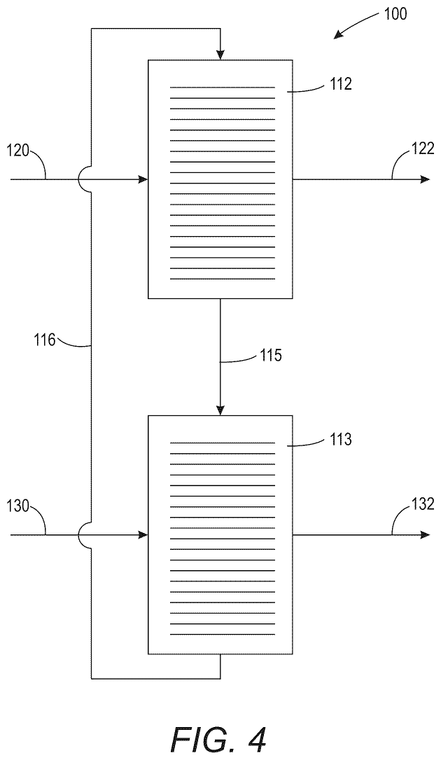

While FIG. 1, FIG. 2, and FIG. 3 illustrate air flow direction is counter-current or opposing the gravity liquid flow direction G, it is understood that the air flow direction may be perpendicular to the gravity liquid flow direction G, or the air flow direction may be in any direction relative to the gravity liquid flow direction G. In some embodiments, the air flow direction is counter-current or opposing the gravity liquid flow direction G. In some embodiments, the air flow direction is perpendicular to the gravity liquid flow direction G, as illustrated in FIG. 4. In some embodiments, the air flow direction is co-incident with the gravity liquid flow direction G.

FIG. 1, FIG. 2, and FIG. 3 illustrate air flowing through the thickness T of each porous media layer 40 in a direction opposing gravity G and liquid flowing through the thickness T of each porous media layer 40 in the direction of gravity G. FIG. 4 illustrates air flowing through the thickness T of each porous media layer 40 in a direction opposing gravity G and liquid flowing through the thickness T of each porous media layer 40 along the length of the porous media layer 40.

The liquid/gas interfaces formed in the liquid/gas contactor unit 10 may be primarily within each porous media layer 40. The air gaps 50 may be at least partially sealed to prevent or restrict air flow 30 along the air gaps 50. The air gaps 50 may be at least partially sealed with air blocking elements 60. The air blocking elements 60 may be disposed between adjacent porous media layers 40. The air blocking elements 60 may be disposed between along the first side surface 46 and the second side surface 48 of each porous media layer 40 as illustrated in FIG. 1 and FIG. 2.

Each porous media layer 40 may be hydrophilic. The porous media layer 40 may be wettable with an aqueous solution. Hydrophilic is defined herein as having a water contact angle of less than 90 degrees, or less than 75 degrees, or less than 50 degrees, or less than 30 degrees. Water contact angle is measured by the standard ASTM D5946.

Each porous media layer 40 may be formed of a hydrophilic material. Hydrophilic materials include polymers. Hydrophilic polymers may include cellulose, polyethylene glycol ethers, polyamides, polyacrylic amides, polyurethanes with polyethylene glycol ether soft segments, or ethoxylated graft polymers, for example. In some embodiments, the plurality of porous media layers 40 are hydrophilic and formed of cellulose.

The liquid/gas contactor unit 10 incudes a plurality of porous media layers 40. The liquid/gas contactor unit 10 may include at least 5 porous media layers 40. The liquid/gas contactor unit 10 may include at least 10 porous media layers 40. The liquid/gas contactor unit 10 may include at least 20 porous media layers 40. The liquid/gas contactor unit 10 may include at least porous media layers 40. The liquid/gas contactor unit 10 may include at least 50 porous media layers 40. The porous media layers 40 may be parallel to each other.

The liquid 20 may be an aqueous solution. The liquid 20 aqueous solution may include a liquid desiccant. A liquid desiccant is hygroscopic and capable of absorbing water. A liquid desiccant is hygroscopic and capable of absorbing water vapor from air contacting the liquid desiccant to condition the air. The liquid desiccant may be capable of being regenerated by releasing the absorbed water from the liquid desiccant. The liquid desiccant may be a glycol, such as tri-ethylene glycol for example. The liquid desiccant may be a halide salt solution.

The halide salt may be selected from sodium chloride (NaCl), potassium chloride (KCl), potassium iodide (KI), lithium chloride (LiCl), copper(II) chloride (CuCl₂), silver chloride (AgCl), calcium chloride (CaCl₂)), chlorine fluoride (ClF), bromomethane (CH₃Br), iodoform (CHIS), hydrogen chloride (HCl), lithium bromide (LiBr) hydrogen bromide (HBr), and combinations thereof. In some embodiments, the halide salt solution is selected from LiCl, NaCl, LiBr, and CaCl₂). In some embodiments, the halide salt solution is LiCl. The halide salt may be present in the liquid desiccant aqueous solution in a range from 2 to 50% wt, or in a range from 10 to 40% wt, or in a range from 20 to 40% wt.

FIG. 3 is a schematic diagram of illustrative porous media layers of a liquid/gas unit 10. Three porous media layers 40 are separated by two air gaps 50. Each porous media layer 40 includes opposing major surfaces 42, 44 that may be parallel to each other. A first major surface 42 is a liquid upstream surface where liquid 20 flows into the porous media layer 40. The liquid flows into the porous media layer 40 and through the porous media layer 40 to the second major surface 44 being the liquid downstream surface 44. Each porous media layer 40 has a length extending from a first side surface 46 to an opposing second side surface 48. The first side surface 46 and the second side surface 48 may define the thickness T of the porous media layer 40.

The liquid 20 moves through the thickness T of the porous media layer 40 with the force of gravity until capillary forces balance the force of gravity and allow the liquid 20 to build up in at the liquid downstream surface 44 of the porous media layer 40. The hydrophilic forces of the porous media layer 40 may also assist in balancing the force of gravity and allow the liquid 20 to build up in at the liquid downstream surface 44 of the porous media layer 40.

Liquid mass build-up or liquid saturation area 41 and open porous area 43 of each porous media layer 40 is illustrated in FIG. 3. This liquid mass build-up area 41 in the porous media layer increases the liquid saturation of the porous media layer 40 to a liquid saturation level above 50%. This liquid mass build-up area 41 in the porous media layer 40 increases the liquid saturation of the porous media layer 40 to a liquid saturation level above 75%. This liquid mass build-up area 41 in the porous media layer 40 increases the liquid saturation of the porous media layer 40 to a liquid saturation level above 85%.

One or more of the porous media layers 40 may include a liquid drip point 70 extending away from the liquid downstream major surface 44 of the porous media layer 40. The liquid drip point 70 is configured to preferentially direct liquid out of the porous media layer 40 and onto an adjacent downstream porous media layer 40. At least selected porous media layers 40 have a drip point 70 on a downstream opposing major surface 44 configured to flow liquid 20 onto an upstream opposing surface 42 of an adjacent and downstream porous media layer 40.

The liquid drip point 70 may be the fixed to the planar liquid downstream major surface 44 of the porous media layer 40. The liquid drip point 70 may alternate from being proximal to or at the first side surface 46 to the opposing second side surface 48 for adjacent porous media layers 40, as illustrated.

A method of forming an air/liquid interface includes providing the liquid/gas contactor unit described herein, and flowing liquid 20 into the liquid inlet 22, through the plurality of porous media layers 40, and out the liquid outlet 24 via gravity G. The liquid 20 flows onto an upstream major surface 42 of each porous media layer 40, through the thickness T of each porous media layer 40, and out a downstream major surface 44 of each porous media layer 40. The method includes flowing air 30 into the air inlet 32, through the plurality of porous media layers 40, and out the air outlet 24. Air 30 flows through the thickness T of the porous media layer 40 forming a liquid/gas interface within the thickness T of the porous media layer 40.

The method may include flowing liquid desiccant 20 into the liquid inlet 22, through the plurality of porous media layers 40, and out the liquid outlet 24 via gravity G. The liquid desiccant is describe above and may include a halide salt solution. The halide salt can be selected from sodium chloride (NaCl), potassium chloride (KCl), potassium iodide (KI), lithium chloride (LiCl), copper(II) chloride (CuCl₂), silver chloride (AgCl), calcium chloride (CaCl₂)), chlorine fluoride (ClF), bromomethane (CH₃Br), iodoform (CHIS), hydrogen chloride (HCl), lithium bromide (LiBr) hydrogen bromide (HBr), and combinations thereof. In some embodiments, the halide salt solution is selected from LiCl, NaCl, LiBr, and CaCl₂). In some embodiments, the halide salt solution is LiCl. The halide salt may be present in the liquid desiccant solution in a range from 2 to 50% wt, or in a range from 10 to 40% wt, or in a range from 20 to 40% wt. The liquid desiccant may remove or add water to the air flowing through the porous media layers 40.

FIG. 4 is a schematic diagram of an illustrative air conditioning system 100 utilizing the liquid/gas contactor units 10 described herein. The air conditioning system 100 includes a liquid desiccant loop 115, 116 including an absorber unit 112 and a desorber unit 113, where liquid desiccant circulates between the absorber unit 112 and a desorber unit 113. The absorber unit 112 and a desorber unit 113 are configured as the liquid/gas contactor unit 10 described herein.

Supply air 120 flows through the absorber unit 112 and humidity is removed from the supply air 120 and forms a loaded liquid desiccant. Conditioned or dehumidified air 122 exists the absorber unit 112.

Fresh air 130 flows into the desorber unit 113. The desorber unit 113 operates at an elevated temperature and regenerates the loaded liquid desiccant removing the added water from the loaded liquid desiccant and humidifying the fresh air 130. The humidified fresh air exists the desorber unit 113 as exhaust air 132. The regenerated liquid desiccant returns to the absorber unit 112 and the process continues.

The concentration value of liquid desiccant in the desorber unit 113 is greater than the concentration value of the liquid desiccant in the absorber unit 112. The concentration value of liquid desiccant in the desorber unit 113 may be 3% or greater, by weight, than the concentration value of the liquid desiccant in the absorber unit 112. The concentration value of liquid desiccant in the desorber unit 113 may be 5% or greater, by weight, than the concentration value of the liquid desiccant in the absorber unit 112. The concentration value of liquid desiccant in the desorber unit 114 may be 8% or greater, by weight, than the concentration value of the liquid desiccant in the absorber unit 112.

The concentration value of liquid desiccant in the desorber unit 113 may be in a range from 3% to 15% greater, by weight, than the concentration value of the liquid desiccant in the absorber unit 112. The concentration value of liquid desiccant in the desorber unit 113 may be in a range from 5% to 10% greater, by weight, than the concentration value of the liquid desiccant in the absorber unit 112.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

1. A liquid/gas contactor unit, comprising;
a unit housing having a liquid inlet and a liquid outlet, and an air inlet and an air outlet, the liquid inlet and the liquid outlet are configured to flow liquid through the unit housing in a gravity liquid flow direction, the air inlet and the air outlet are configured to flow air through the unit housing in an air flow direction;
a plurality of porous media layers contained within the unit housing and along the air flow, each porous media layer is separated from an adjacent porous media layer by an air gap, each porous media layer comprises opposing major surfaces separated by a thickness, the opposing major surfaces are orthogonal to the gravity liquid flow direction.

2. The liquid/gas contactor unit according to claim 1, wherein the air gaps are at least partially sealed to prevent or restrict air flow along the air gap.

3. The liquid/gas contactor unit according to claim 1, wherein the plurality of porous media layers comprises at least 5 porous media layers.

4. The liquid/gas contactor unit according to claim 1, wherein the plurality of porous media layers comprises at least 10 porous media layers.

5. The liquid/gas contactor unit according to claim 1, wherein the plurality of porous media layers comprises at least 20 porous media layers.

6. The liquid/gas contactor unit according to claim 1, wherein the air flow direction is counter-current or opposing to the gravity liquid flow direction.

7. The liquid/gas contactor unit according to claim 1, wherein the air flow direction is orthogonal to the gravity liquid flow direction.

8. The liquid/gas contactor unit according to claim 1, wherein liquid desiccant flows from the liquid inlet to the liquid outlet.

9. The liquid/gas contactor unit according to claim 8, wherein the liquid desiccant comprises a halide salt solution.

10. The liquid/gas contactor unit according to claim 1, wherein the plurality of porous media layers are hydrophilic.

11. The liquid/gas contactor unit according to claim 1, wherein the plurality of porous media layers are hydrophilic and formed of a polymer.

12. The liquid/gas contactor unit according to claim 1, wherein the plurality of porous media layers are hydrophilic and formed of cellulose.

13. The liquid/gas contactor unit according to claim 1, wherein at least selected porous media layers have a drip point on a downstream opposing major surface configured to flow liquid onto an upstream opposing surface of an adjacent and downstream porous media layer.

14. The liquid/gas contactor unit according to claim 1, wherein the plurality of porous media layers each have a thickness value and a length value, the thickness value is co-incident with the gravity liquid flow direction, the plurality of porous media layers each have an aspect ratio (length:thickness) of at least 10:1, or at least 50:1, or at least 100:1.

15. The liquid/gas contactor unit according to claim 14, wherein the thickness is in a range from 5 mm to 50 mm.

16. A method of forming an air/liquid interface, comprising,
providing the liquid/gas contactor unit according to claim 1;
flowing liquid into the liquid inlet, through the plurality of porous media layers, and out the liquid outlet via gravity, wherein the liquid flows onto an upstream major surface of each porous media layer, through the thickness of each porous media layer, and out a downstream major surface of each porous media layer; and
flowing air into the air inlet, through the plurality of porous media layers, and out the air outlet, air flows through the thickness of the porous media layer forming a liquid/gas interface within the thickness of the porous media layer.

17. The method according to claim 16, wherein the flowing liquid comprises liquid saturating at least 50% of each porous media layer.

18. The method according to claim 16, wherein the flowing liquid comprises flowing liquid desiccant into the liquid inlet, through the plurality of porous media layers, and out the liquid outlet via gravity.

19. The method according to claim 18, wherein the liquid desiccant comprises a halide salt solution.

20. The method according to claim 18, wherein the liquid desiccant removes or adds water to the air flowing through the porous media layers.
